(19) United States
(12) Patent Application Publication
(10) Pub. No.: US 2024/0239569 A1
(43) Pub. Date: Jul. 18, 2024

(54) LIQUID DISPENSER AND PROTECTIVE CAP FOR A LIQUID DISPENSER

(71) Applicant: Aptar Radolfzell GmbH, Radolfzell (DE)

(72) Inventor: Jürgen GREINER-PERTH, Gottmadingen (DE)

(21) Appl. No.: 18/559,364

(22) PCT Filed: May 5, 2022
(86) PCT No.: PCT/EP2022/062112

§ 371 Date: Nov. 7, 2023

(30) Foreign Application Priority Data
May 19, 2021 (EP) 21174812.4

(51) Int. Cl. B65D 51/16

(52) U.S. Cl. CPC B65D 51/16

(57) ABSTRACT

A liquid dispenser for dispensing in pharmaceutical liquids via a discharge or dispensing opening protected by a protective cap. The protective cap has a fastening part, designed for coupling to a housing of the liquid dispenser, and an inner part separate from the fastening part. The inner part, when the protective cap is in a fitted state, protects the discharge opening. The inner part is captively coupled to the fastening part by a coupling device, and the inner part is freely rotatable about a longitudinal axis of the protective cap in relation to the fastening part.

### FIELD OF APPLICATION AND PRIOR ART

The invention relates to a liquid dispenser and in particular to the protective cap thereof.

A liquid dispenser of the generic type has a liquid store, which can be filled in particular with a pharmaceutical liquid. The liquid dispenser is used to dispense the liquid through a discharge opening, for example in the form of droplets which are applied to the eyes of a patient.

In order to protect the discharge opening, a liquid dispenser of the generic type comprises a protective cap which is fitted onto a housing of the liquid dispenser when the latter is not in use. The protective cap protects the discharge opening against external mechanical influences. It may additionally perform further functions, such as in particular ventilation of the discharge opening or absorption of residual liquid at the discharge opening.

In the fitted state, a protective cap of the generic type bears sealingly against a housing of the liquid dispenser. If the protective cap is removed, this sealing point is interrupted, but the relative movement of the protective cap and the housing is made difficult by the friction prevailing at the sealing point and wear may occur here, which impairs the sealing action when the cap is fitted again.

US 2015/0043958 A1 discloses a protective cap which has an inner cap and an outer cap. In the fitted state, the inner cap surrounds the discharge opening and is secured on a housing of the liquid dispenser by means of a screw connection. The outer cap is initially movable in relation to the inner cap, specifically in a superimposed rotational and linear movement. This relative movement allows a path to be opened via which residual liquid can escape from the discharge opening when the cap is fitted.

EP 3119529 B1 discloses a protective cap which has an absorption buffer, which is inserted into a ring body in order to facilitate the mounting in the protective cap.

### Problem and Solution

The problem addressed by the invention is that of providing a liquid store and the protective cap thereof which enable repeatedly satisfactory liquid sealing and nevertheless enable simple removal of the protective cap.

For this purpose, the invention proposes a liquid dispenser which comprises, in a known manner, a liquid store in which the liquid is stored prior to discharge. Depending on the application purpose, said liquid store preferably has a volume of less than 200 mL, in particular of less than 50 mL. The liquid dispenser furthermore comprises a housing and a discharge opening through which the liquid can be dispensed into an environment. The discharge opening may be provided passing directly through the housing or on an actuating pushbutton which is movable in relation to the housing. A pump device is preferably provided for the conveyance of liquid from the liquid store to the discharge opening. Said pump device may be actuated by the mentioned actuating pushbutton. However, it is particularly advantageous if an actuating button separate from the discharge opening is provided for actuating the pump device, particularly preferably laterally on a shell surface of the housing.

The liquid dispenser is preferably configured for the discharge of pharmaceutical liquids. Correspondingly, in the delivery state the liquid store is preferably filled with such a liquid. However, other fields of application are also encompassed, in particular cosmetic liquids, technical liquids and foodstuffs.

In particular, the design according to the invention of a liquid dispenser is configured for the dispensing of droplets. In the case of such a droplet dispenser, the discharge opening is assigned a droplet forming contour downstream of the discharge opening. Here, the liquid accumulates in order to then come loose in the form of droplets, for example for application into an eye. Particularly in the case of pharmaceutical liquids which are dispensed in droplet form and which accordingly accumulate on an outer surface of the dispenser during use as intended, there is the risk of contamination of residual liquid.

A liquid dispenser according to the invention comprises a protective cap according to the invention. In the fitted state, this protective cap protects the discharge opening and is removable for the purpose of discharging liquid, in particular by being unscrewed from the housing for this purpose.

The protective cap comprises at least two components, specifically a fastening part and an inner part.

The fastening part is configured for coupling to the housing of the liquid dispenser. The main function of the fastening portion is, accordingly, the mechanical coupling of the protective cap to the housing, for example by means of a thread in the case of a screw cap, or by means of a clamping region in the case of a push-on cap, said clamping region forming a frictionally retaining clamping connection with an outer contour of the housing.

The protective cap furthermore comprises the mentioned inner part which is separate from the fastening part. In the fitted state of the protective cap, said inner part surrounds the discharge opening. For this, it forms, together with the surfaces surrounding the discharge opening, a discharge opening space and seals the latter in relation to the housing or an actuating pushbutton of the liquid dispenser.

The inner part is captively coupled to the fastening part by means of a coupling device, wherein said inner part is freely rotatable in relation to the fastening part about a longitudinal axis of the protective cap.

Designing the cap with a fastening part and an inner part which are attached to one another so as to be rotatable in relation to one another about the longitudinal axis leads to a number of advantages. In particular, it brings about a decoupling which is advantageous in particular with regard to the sealing point formed by the inner part. For example when unscrewing a protective cap in the form of a screw cap, the fastening part can, at least initially, continue to bear against the housing in a rotationally fixed manner, while the fastening part is already displaced and rotated. This avoids wear at the sealing point.

Furthermore, the removal of the cap is also simplified, since it is no longer necessary to apply a force or a torque directly in order to overcome the friction at the sealing point. Instead, in the case of a screw cap, initially only the fastening part is rotated. Only after said fastening part has been displaced over a certain distance axially in relation to the housing does a resulting pulling force act indirectly on the inner part with sufficient strength to pull the latter off from the housing. The required expenditure of force for releasing the screw coupling or plug-on coupling between the housing and fastening part is thus decoupled in terms of time from the required expenditure of force for releasing the inner part from the housing.

An advantage of the separate design of the inner part and the fastening part is also the possibility of using different materials. It is thus possible to use materials which are well adapted in each case to the main function. The material choice for the fastening part may be effected in particular with regard to the fastening function. Preferably, a relatively hard plastic with a low-friction surface is advantageous for the thread. A relatively soft material is advantageous for the inner part and its main function of sealing with the housing.

A further advantage of the separate configuration of the inner part and the fastening part is afforded when the inner part is tiltable at least to a limited extent in relation to the fastening part. What is achieved thereby is that even plugging on or screwing on of the fastening part with a slightly inclined orientation does not result in a likewise inclined fitting of the inner part and thus an impaired sealing action. Rather, in particular by way of a shape which widens conically or in some other way at the open end so as to correspond to the housing, the inner part can be oriented by itself in a manner decoupled from the fastening part and thus obtain an ideal sealing action.

The risk of a mechanical loading of the fastening part, which forms an outer sleeve, impairing the sealing action at the sealing point between the housing and the protective cap is also reduced. A mechanical impact on the fastening part causes a relative displacement with respect to the inner part rather than a sealing point between the inner part and the housing of the liquid dispenser being unintentionally opened.

Preferably, the movability of the inner part in relation to the fastening part is not limited to the rotational movability and possibly a tilting movability, but rather an axial movability may in particular also be provided. Particularly preferably, the inner part is axially movable in relation to the fastening part between two end positions by at least 0.5 mm, preferably by at least 1 mm. This has the effect that when pulling off or unscrewing the protective cap, the sealing point is released only after the fastening part has already been displaced axially in relation to the housing by a corresponding distance.

In order to receive the inner part and to obtain the movability between the inner part and the fastening part, provision is preferably made for the fastening part to define a receiving space in which the inner part is captively arranged. This receiving space is preferably terminated toward an open end of the fastening part, that is to say pointing in the direction of the actual dispenser or the liquid store thereof, by an inwardly pointing retaining edge which is provided in particular on a circumferential and inwardly pointing web. The retaining edge has a clear cross section which is smaller than the outer diameter of the inner part, such that during mounting the inner part is pushed thereover, in particular by means of lead-in bevels provided at the retaining edge, and then latches into the receiving space. Opposite the retaining edge, the receiving space is preferably delimited by an end wall of the fastening part.

Preferably, the retaining edge on the fastening part is in the form of a circumferential retaining edge of uniform inner diameter. However, the retaining edge on the fastening part may also be formed by a plurality of retaining edge portions arranged in a circumferentially offset manner.

Furthermore, a retaining edge which cooperates with the retaining edge on the fastening part and which particularly preferably defines a circumferentially uniform outer diameter is preferably provided on the inner part. Particularly preferably, the retaining edge of the inner part is provided on an outwardly protruding circumferential web.

Preferably, the protective cap has a ventilation path via which, when the protective cap is fitted, the discharge opening is connected to an atmosphere surrounding the liquid dispenser. This means that even when the protective cap is fitted, air can enter the discharge opening space and promotes the rapid drying of residual liquid at the discharge opening.

The ventilation path is preferably realized by virtue of the fastening part and the inner part each comprising at least one aperture. The ventilation path extends through these two apertures. Preferably, the apertures are in each case provided on an end surface of the inner part and of the fastening part.

The protective cap preferably has a sterile filter arranged in the ventilation path. Said sterile filter may be provided in the region of the aperture in the fastening part and filter the air flowing through this aperture. Particularly preferably, however, the sterile filter is provided at the aperture in the inner part and spans said aperture. When the protective cap is fitted, the discharge opening chamber is connected to the environment exclusively through the sterile filter.

In the context of the invention, the sterile filter is a filter which is in the form of a depth filter or preferably in the form of a membrane filter and which has a separation limit suitable for removing at least 99.9% of all bacteria from the inflowing ambient air. Preferably, the sterile filter has a separation limit of 0.3 μm or less, particularly preferably of 0.2 μm or less. The sterile filter in particular allows the liquid dispenser to be delivered with an open ventilation channel. However, it may be advantageous for the ventilation channel to be closed in the delivery state, for example by means of an adhesive label which spans an aperture.

Preferably, as an alternative to the sterile filter or in particular in addition to the sterile filter, the protective cap comprises an absorption pad which is provided on the inner part and which is arranged in the discharge opening space in such a way that it lies at the discharge opening when the protective cap is fitted, in order to absorb the liquid remaining here after a discharge operation. The absorption pad may also be arranged at a slight spacing from the discharge opening, as long as it reaches the vicinity, in order to be able to absorb a residual droplet from the discharge opening or from the surrounding discharge contour.

The absorption pad is preferably composed of a fiber material or a porous material. It may be of rigid or elastically deformable form. In particular, the material of the absorption pad may exhibit hydrophilic properties, in order to be able to rapidly absorb liquid and to thus be able to remove it from the discharge opening.

Particularly preferably, the sterile filter and the absorption pad are formed as two layers of the same layer composite, it being possible for them to be connected to one another directly or indirectly by way of a common fastening on the inner part.

This layer composite or the absorption pad or the sterile filter is fastened in the inner part or possibly to the fastening part preferably by overmolding. In particular, the fastening part, the absorption pad or the layer composite is engaged around on both sides by the retaining component in an integral manner. The overmolding produces a particularly close and tight connection between the plastic of the inner part or of the fastening part and a periphery of the sterile filter or of the absorption pad.

The fastening part and the inner part preferably each comprise a lateral surface and an end-side end wall. The apertures are preferably each provided in this end wall, since this simplifies the production. The apertures are preferably aligned with one another, it being advantageous for a narrowest diameter or a narrowest clear width of the aperture in the fastening part to be at most 5 mm. This prevents a sterile filter provided at the aperture of the inner part from being damaged inadvertently from outside.

As already mentioned above, the protective cap is preferably in the form of a screw cap. It is accordingly equipped with a thread, in particular an internal thread, which is provided on the fastening part. The counterpart thread, preferably an external thread, is provided on the outer side of the housing of the liquid dispenser.

However, other designs of the protective cap are also encompassed, in particular a plug-on cap which does not have to be rotated for fitting and removal purposes, but rather is simply pulled off or fitted without any rotational movement. In the case of such a plug-on cap, the fastening part is configured to form a clamping connection with the housing. For the purpose of obtaining a clamping connection, the outer diameter of the housing and a clamping region of the plug-on cap are matched to one another. Since the fastening part does not have to perform any function with regard to the sealing of the cap, the internal clamping region may be designed, in particular, with elongate ribs, in order to simultaneously enable a good clamping action and a simple pulling-off operation.

### BRIEF DESCRIPTION OF THE DRAWINGS

Further advantages and aspects of the invention will emerge from the claims and from the following description of preferred exemplary embodiments of the invention, which are explained below with reference to the figures.

FIG. 1 shows a sectional illustration of a liquid dispenser according to the invention.

FIG. 2 shows a sectional illustration of the protective cap of the liquid dispenser according to FIG. 1.

FIG. 3 shows a sectional illustration of a second variant of a protective cap according to the invention.

### DETAILED DESCRIPTION OF THE EXEMPLARY EMBODIMENTS

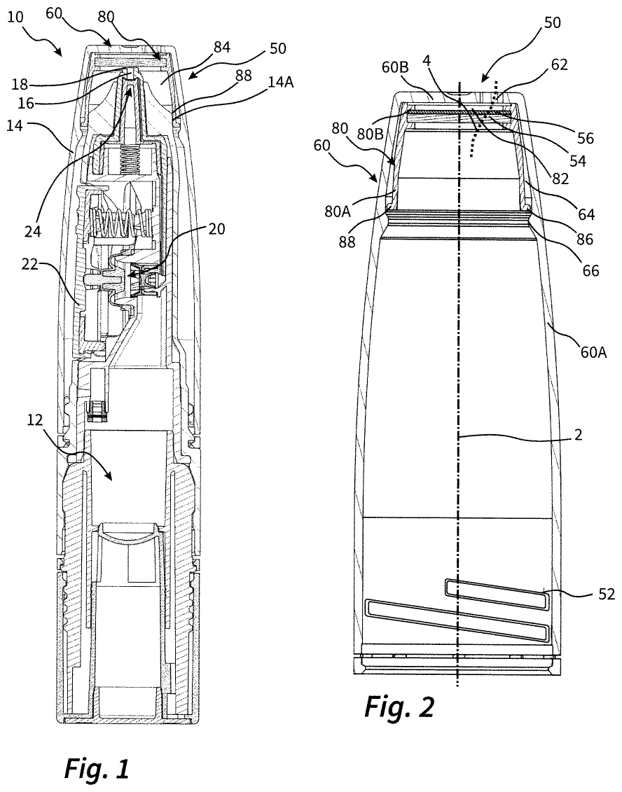

FIGS. 1 and 2 show a liquid dispenser according to the invention and the protective cap thereof.

In the present case, the liquid dispenser 10 is in the form of a droplet dispenser. It has a liquid store 12, a pump device 20 and a discharge opening 16 which are surrounded by a droplet forming surface 18. As a droplet dispenser, the liquid dispenser 10 is used, for the intended purpose, in an overhead position, in which the discharge opening 16 points downward. In this position, the user presses in an actuating button 22, by means of which liquid is conveyed by the pump device 20 from the liquid store 12 in the direction of the discharge opening 16. Upstream of the discharge opening 16 is a discharge valve 24 which opens in the event of sufficient pressure and allows the liquid to escape to the droplet forming surface 18.

In order to protect in particular the discharge opening 16, but also the actuating button 22, provision is made of a protective cap 50 which is illustrated separately and in enlarged form in FIG. 2. The protective cap 50 has two main components, specifically a fastening part 60 and an inner part 80.

The fastening part 60 comprises a lateral wall 60A and an end wall 60B. An internal thread 52 is provided at the lower end of the lateral wall 60A in the perspective view of FIG. 2, since the protective cap 50 is in the form of a screw cap. Correspondingly thereto, an external thread is provided on the outer side of the housing 14 of the liquid dispenser 10.

Furthermore, a ring-like tamper-evident portion 70 is provided at the mentioned lower end of the protective cap 50 and is connected to the lateral wall 60A by means of thin plastics bridges. The end wall 60B is passed through by an aperture 62. On the inner side, the protective cap 50 comprises a circumferential retaining web with a retaining edge 66 which downwardly delimits a receiving space 64 of the fastening part 60.

The already mentioned inner part 80 is arranged in this receiving space 64. Said inner part also comprises a lateral wall 80A and an end wall 80B. An outwardly pointing retaining web with a retaining edge 86 secures the inner part 80 in relation to the fastening part 60. However, the receiving space 64 is dimensioned such that the inner part 80 is movable therein, specifically is rotatable in relation to the fastening part 60 in particular about the longitudinal axis 2.

The end wall 80B, like the end wall 60B, is provided with an aperture 82, this aperture being spanned by a layer composite composed of a sterile filter 56 and an absorption pad 54. This layer composite is overmolded, in its peripheral region, by the plastics material of the inner part 80.

In addition to the rotational movability, the inner part 80 is also axially displaceable in relation to the fastening part 60 in the direction of the longitudinal axis 2, preferably by approximately 0.5 to 1 mm.

If the protective cap 50 is fitted in the manner illustrated in FIG. 1, an inner side 88 of the lateral wall 80A effects sealing with a slightly tapering sealing surface 14A of the housing 14 and thus prevents gas exchange here.

Entry of air into the receiving space 64 and into the outlet opening space 84 defined by the inner body is nevertheless possible along a ventilation path 4 through the apertures 62, 82, the air entering here being freed from bacteria by the sterile filter 56.

The two-part configuration of the protective cap obtains very good sealing at the sealing point 88, 14A. If the screw cap 50 is unscrewed, a circumferential frictional relative movement between the sealing surfaces 88, 14A does not occur. Instead, only the fastening part 80 is rotated. Only after said fastening part has been displaced to some extent axially on account of the thread 52 is the inner part 80 pulled off from the housing 14.

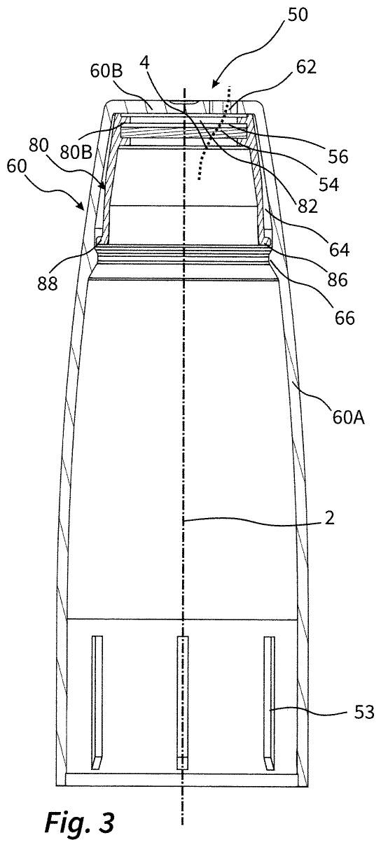

FIG. 3 shows an alternative design of the protective cap 50. This is in the form of a plug-on cap. Correspondingly, instead of the thread 52, it comprises ribs, the interior surfaces of which form clamping surfaces 53.

1. A liquid dispenser for discharge of liquids, comprising
a liquid store, the liquid store storing liquid prior to discharge;
a housing; a discharge opening, the liquid being dispensable through the discharge opening into an environment; and
a protective cap, the protective cap, in fitted state, protecting the discharge opening and being removable for discharging liquid, the protective cap comprising
a fastening part configured for coupling to the housing; of the liquid dispenser,
an inner part separate from the fastening part, the inner part in the fitted state of the protective cap surrounding the discharge opening,
the inner part being captively coupled to the fastening part by a coupling device, said inner part being freely rotatable in relation to the fastening part about a longitudinal axis of the protective cap.

2. The liquid dispenser as claimed in claim 1, wherein
the protective cap has a ventilation path, and when the protective cap is in the fitted state, the discharge opening is connected to an atmosphere surrounding the liquid dispenser via the ventilation.

3. The liquid dispenser as claimed in claim 2, wherein
the fastening part and the inner part each comprise at least one aperture, the ventilation path extending through the at least one aperture of each of the fastening part and the inner part.

4. The liquid dispenser as claimed in claim 3, wherein:
the protective cap has a sterile filter arranged in the ventilation path and spanning either the at least one aperture in the fastening part or the at least one aperture in the inner part; and/or
the protective cap has an absorption pad provided on the inner part, and the absorption pad when the protective cap is in the fitted state, lies at the discharge opening or is arranged immediately adjacent the discharge opening.

5. The liquid dispenser as claimed in claim 4, wherein the at least one
aperture in the fastening part is aligned with the sterile filter and/or the absorption pad.

6. The liquid dispenser as claimed in claim 1, wherein
the protective cap a screw cap having an internal thread arranged on the fastening part.

7. The liquid dispenser as claimed in claim wherein
the protective cap comprises a push-on cap and the fastening part include an interior clamping surface.

8. The liquid dispenser as claimed in claim 1, wherein
the inner part is fastened to the fastening part in an axially movable manner.

9. The liquid dispenser as claimed in claim 1, wherein
the fastening part comprises a receiving space, the inner part being captively arranged in the receiving space, in the receiving space terminating at an open end of the fastening part at a retaining edge, the retaining edge defining a free cross section smaller than an outer diameter of the inner part.

10. The liquid dispenser as claimed in claim 1, wherein
the inner part and the fastening part are composed of different materials.

11. The liquid dispenser as claimed in claim 1, wherein
the liquid store is filled with a pharmaceutical liquid; and/or
the liquid store has a volume of at most 200 mL and/or
the liquid dispenser has a pump device; and/or
the liquid dispenser is in the form of a droplet dispenser and the liquid dispenser includes a droplet forming contour downstream of the discharge opening.

12. A protective cap for a liquid dispenser having a housing and a discharge opening, the protective cap comprising
a fastening part configured for coupling to the housing of the liquid dispenser,
the protective cap comprising an inner part separate from the fastening part, the inner part in a fitted state of the protective cap on the liquid dispenser, surrounding the discharge opening, the protective cap further comprising a coupling device,
the inner part being coupled to the fastening part by the coupling device such that said inner part is freely rotatable in relation to said fastening part about a longitudinal axis of the protective cap.

13. The protective cap as claimed in claim 12, comprising at least one of the following additional features:
the protective cap has a ventilation path and when the protective cap is in the fitted state, the discharge opening of the liquid; is connected to an atmosphere surrounding the liquid dispenser; and/or
the fastening part and the inner part each comprise at least one aperture the ventilation path extending through the at least one aperture of both of the fastening part and the inner; and/or
the protective cap has a sterile filter arranged in the ventilation path and spanning either the at least one aperture in the fastening part or the at least one aperture in the inner part; and/or
the protective cap has an absorption pad provided on the inner part and which, when the protective cap is in the fitted state, the absorption pad lies at the discharge opening of the liquid dispenser or is arranged immediately adjacent the discharge opening; and/or
the at least one aperture in the fastening part is a with the sterile filter and/or the absorption pad and/or
the protective cap comprises a screw cap having an internal thread arranged on the fastening part, or
the protective cap comprises a push-on cap and an interior clamping surface is provided on the fastening part; and/or
the inner part is fastened to the fastening part in an axially movable manner; and/or
the fastening part comprises a receiving space, the inner part being captively arranged in the receiving space, the receiving space terminating at an open end of the fastening part at a retaining edge, the retaining edge defining a clear cross section smaller than an outer diameter of the inner part; and/or
the inner part and the fastening part are composed of different materials.

14. The liquid dispenser as claimed in claim 4, wherein:
the absorption pad comprises a hydrophilic material; and/or
the absorption pad comprises a fiber material or a porous material; and/or
the sterile filter has a separation limit of 0.3 μm or less; and/or
the absorption pad and/or the sterile filter is connected to the fastening part or to the inner part by overmolding.

15. The liquid dispenser as claimed in claim 5,
wherein the at least one aperture in the fastening part has a narrowest diameter of at most 5 mm.

16. The liquid dispenser as claimed in claim 8, wherein the inner part is axially movable in relation to the fastening part by at least 0.5 mm.

17. The liquid dispenser as claimed in claim 9, wherein:
the retaining edge on the fastening part comprises a circumferential retaining edge of a uniform inner diameter;
and/or the inner part has a retaining edge, said retaining edge cooperating with the retaining edge on the fastening part, the retaining edge of the inner part having a circumferentially uniform outer diameter.

18. The liquid dispenser as claimed in claim 10, wherein the material of the inner part is softer than the material of the fastening part.

19. The liquid dispenser as claimed in claim 11, further including an actuating button for actuating the pump device, the actuating button being disposed on a lateral surface of the housing and being pushable radially inward.

20. The liquid dispenser as claimed in claim 19, wherein the protective cap covers the actuating button in the fitted state.
